(19) United States
(12) Patent Application Publication
(10) Pub. No.: US 2021/0101682 A1
(43) Pub. Date: Apr. 8, 2021

(54) METHODS AND DEVICES FOR UNMANNED AERIAL VEHICLES, SPRAYING SYSTEMS, UNMANNED AERIAL VEHICLES, AND STORAGE MEDIA

(71) Applicant: SZ DJI TECHNOLOGY CO., LTD., Shenzhen (CN)

(72) Inventor: Liyao ZHAO, Shenzhen (CN)

(73) Assignee: SZ DJI TECHNOLOGY CO., LTD., Shenzhen (CN)

(21) Appl. No.: 17/125,672

(22) Filed: Dec. 17, 2020

Related U.S. Application Data
(63) Continuation of application No. PCT/CN2019/084979, filed on Apr. 29, 2019.

(51) Int. Cl. B64D 1/18; A01M 7/00; B05B 12/16; G05D 1/12; G05D 1/00; B64C 39/02

(52) U.S. Cl. CPC B64D 1/18; A01M 7/0089; B05B 12/16; B64C 2201/127; G05D 1/0094; B64C 39/024; G05D 1/12

(57) ABSTRACT

The present disclosure provides methods and devices for controlling unmanned aerial vehicles, spraying systems, unmanned aerial vehicles, and storage media. The method includes: obtaining location information of an unmanned aerial vehicle having a plurality of nozzles disposed thereon and attitude information of the unmanned aerial vehicle; for each nozzle: determining a spraying area corresponding to the nozzle in a target area based on the location information and the attitude information; determining whether there are one or more target object in the spraying area corresponding to the nozzle; controlling the nozzle to be ON in response to determining that there are one or more target objects in the spraying area; and controlling the nozzle to be OFF in response to determining that there is no target object in the spaying area.

### RELATED APPLICATIONS

The present patent document is a continuation of PCT Application Serial No. PCT/CN2019/084979, filed on Apr. 29, 2019, designating the United States and published in Chinese, contents of which is herein incorporated by reference in its entirety.

### BACKGROUND

### 1. Technical Field

The present disclosure relates to the technical field of unmanned aerial vehicles, and in particular, to methods and devices for controlling unmanned aerial vehicles, spraying systems, unmanned aerial vehicles, and storage media.

### 2. Background Information

In conventional techniques, an unmanned aerial vehicle, for example, an agricultural unmanned aerial vehicle, may be used for spraying operations. For example, a plurality of nozzles and a tank for carrying pesticides are disposed on the agricultural unmanned aerial vehicle. When there are crops below the agricultural unmanned aerial vehicle, the agricultural unmanned aerial vehicle turns on all nozzles and controls the plurality of nozzles to simultaneously spray pesticide down.

However, the spraying manner in the prior art causes a great waste of pesticide.

### BRIEF SUMMARY

This summary is provided to introduce a selection of implementations in a simplified form that are further described below. This summary is not intended to identify all features of the claimed subject matter, nor is it intended to be used alone as an aid in determining the scope of the claimed subject matter.

Exemplary embodiments of the present disclosure provide methods and devices for controlling unmanned aerial vehicles, spraying systems, unmanned aerial vehicles, and storage media, to avoid great waste of pesticide when the unmanned aerial vehicle is performing a spraying task.

A first aspect of embodiments of the present disclosure provides a method for controlling an unmanned aerial vehicle. The method includes: obtaining location information of an unmanned aerial vehicle having a plurality of nozzles disposed thereon and attitude information of the unmanned aerial vehicle; for each nozzle: determining a spraying area corresponding to the nozzle in a target area based on the location information and the attitude information; determining whether there are one or more target object in the spraying area corresponding to the nozzle; controlling the nozzle to be ON in response to determine that there are one or more target objects in the spraying area; and controlling the nozzle to be OFF in response to determine that there is no target object in the spaying area.

A second aspect of embodiments of the present disclosure provides a device for controlling an unmanned aerial vehicle. The device includes: one or more storage media storing one or more sets of instructions for controlling an unmanned aerial vehicle; and one or more processors, during operation, to execute the one or more sets of instructions to: obtain location information of an unmanned aerial vehicle having a plurality of nozzles disposed thereon and attitude information of the unmanned aerial vehicle, and for each nozzle: determine a spraying area corresponding to the nozzle in a target area based on the location information and the attitude information; determining whether there are one or more target object in the spraying area corresponding to the nozzle; controlling the nozzle to be ON in response to determine that there are one or more target objects in the spraying area; and controlling the nozzle to be OFF in response to determine that there is no target object in the spaying area.

A third aspect of embodiments of the present disclosure provides a spraying system of an unmanned aerial vehicle. The spraying system includes: a plurality of nozzles, mounted on a fuselage of the unmanned aerial vehicle; a nozzle control system, configured to control the plurality of nozzles to be ON or OFF; and a control device, including: one or more storage media storing one or more sets of instructions for controlling an unmanned aerial vehicle; and one or more processors, during operation, to execute the one or more sets of instructions to: obtain location information of an unmanned aerial vehicle having a plurality of nozzles disposed thereon and attitude information of the unmanned aerial vehicle; for each nozzle: determine a spraying area corresponding to the nozzle in a target area based on the location information and the attitude information; determining whether there are one or more target object in the spraying area corresponding to the nozzle; controlling the nozzle to be ON in response to determine that there are one or more target objects in the spraying area; and controlling the nozzle to be OFF in response to determine that there is no target object in the spaying area.

In the control method and device for an unmanned aerial vehicle, the spraying system, the unmanned aerial vehicle, and the storage medium provided by the embodiments, by determining the spraying area of each nozzle in the target area based on the location information of the unmanned aerial vehicle and the attitude information of the unmanned aerial vehicle and further determining whether there are crops in the spraying area corresponding to each nozzle, which nozzle corresponds to a spraying area with crops and which nozzle corresponds to a spraying area without crops can be determined; and if there are crops in the spraying area of a nozzle, the nozzle is controlled to be ON, otherwise, the nozzle is controlled to be OFF. Therefore, waste of pesticide can be effectively avoided in comparison with an operation mode of turning on all nozzles of an unmanned aerial vehicle to spray simultaneously.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show some exemplary embodiments of the present disclosure, and persons of ordinary skill in the art may still derive other drawings from these accompanying drawings without creative efforts.

FIG. 1 is a flowchart of a method for controlling an unmanned aerial vehicle according to some exemplary embodiments of the present disclosure;

FIG. 2 is a schematic diagram of a spraying area of a nozzle in a target area according to some exemplary embodiments of the present disclosure;

FIG. 3 is another schematic diagram of a spraying area of a nozzle in a target area according to some exemplary embodiments of the present disclosure;

FIG. 4 is still another schematic diagram of a spraying area of a nozzle in a target area according to some exemplary embodiments of the present disclosure;

FIG. 5 is yet another schematic diagram of a spraying area of a nozzle in a target area according to some exemplary embodiments of the present disclosure;

FIG. 6 is yet another schematic diagram of a spraying area of a nozzle in a target area according to some exemplary embodiments of the present disclosure;

FIG. 7 is a flowchart of a method for controlling an unmanned aerial vehicle according to another embodiment of the present disclosure;

FIG. 8 is a flowchart of a method for controlling an unmanned aerial vehicle according to another embodiment of the present disclosure;

FIG. 9 is a schematic diagram of grid areas and a plurality of unit areas according to another embodiment of the present disclosure;

FIG. 10 is a structural diagram of a control device for an unmanned aerial vehicle according to some exemplary embodiments of the present disclosure; and

FIG. 11 is a structural diagram of an unmanned aerial vehicle according to some exemplary embodiments of the present disclosure.

### REFERENCE NUMERALS

21: unmanned aerial vehicle; 22: nozzle; 23: target area;
24: spraying area; 30: circle; 31: outer-tangent rectangular area;
41: circular area; 42: nozzle; 43: nozzle;
44: nozzle; 51: circle; 412: gridded area;
413: gridded area; 414: gridded area; 415: gridded area;
60: outer-tangent rectangular area; 62: circular area; 63: circular area;
64: circular area; 65: circular area; 81: grid area;
82: grid area; 83: grid area; 84: grid area;
85: grid area; 86: grid area; 87: grid area;
88: grid area; 89: grid area; 821: unit area;
822: unit area; 100: control device; 101: memory;
102: processor; 103: communication interface; 110: unmanned aerial vehicle;
107: motor; 106: propeller; 117: electronic speed governor;
118: flight controller

### DETAILED DESCRIPTION OF THE DRAWINGS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure without creative efforts shall fall within the protection scope of the present disclosure.

It should be noted that, when a component is described as “fixed” to another component, the component may be directly located on another component, or an intermediate component may exist therebetween. When a component is considered as “connected” to another component, the component may be directly connected to another element, or an intermediate element may exist therebetween.

Unless otherwise defined, meanings of all technical and scientific terms used in this specification are the same as those generally understood by persons skilled in the art of the present disclosure. The terms used in this specification of the present disclosure herein are used only to describe specific embodiments, and not intended to limit the present disclosure. The term “and/or” used in this specification includes any or all possible combinations of one or more associated listed items.

The following describes in detail some implementations of the present disclosure with reference to the accompanying drawings. Under a condition that no conflict occurs, the following embodiments and features in the embodiments may be mutually combined.

The terminology used herein is for the purpose of describing particular exemplary embodiments only and is not intended to be limiting. When used in this disclosure, the terms “comprise”, “comprising”, “include” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In some exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in some exemplary embodiments, the numerical parameters set forth in the written description and the appended claims are approximations, which may vary depending upon the desired properties sought to be obtained in a particular embodiment. In some exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the technical solution in this application in accordance with the embodiments of the present application. Therefore, the embodiments of the present application are not limited to those embodiments that have been precisely described in this disclosure.

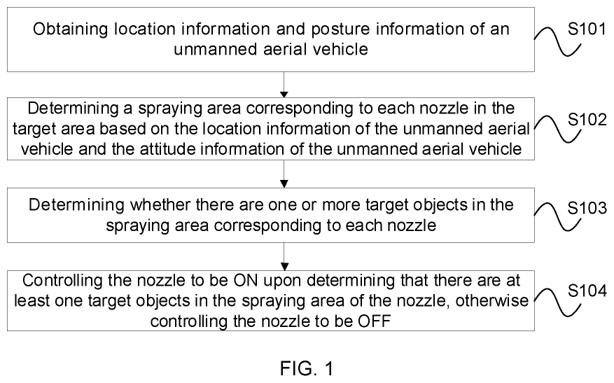

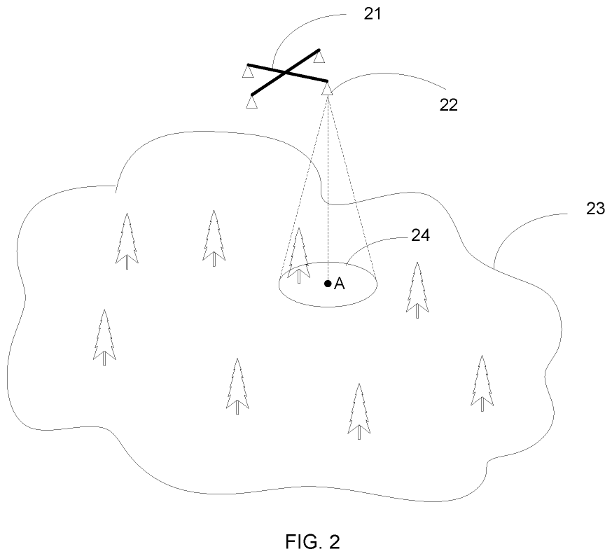

The exemplary embodiments of the present disclosure provides a method for controlling an unmanned aerial vehicle. FIG. 1 is a flowchart of a method for controlling an unmanned aerial vehicle according to some exemplary embodiments of the present disclosure. In these exemplary embodiments, a plurality of nozzles may be disposed on the unmanned aerial vehicle, and the nozzles may be configured to perform a spraying task on a plurality of target objects in a target area. For example, the plurality of target objects may be crops, and the spray task may be spraying pesticides or fertilizer. In another example, the plurality of target objects may be objects on fire, and the spraying task may be spraying fire extinguishing agents. Merely for illustration purpose, in the following description, the present disclosure takes crops as an example of the target objects. However, one of ordinary skill in the art would understand that the target object may be any other things applicable to the methods, devices, spraying systems, and unmanned aerial vehicles introduced in the present disclosure. As shown in FIG. 2, a plurality of nozzles 22 may be disposed on an unmanned aerial vehicle 21. Herein, the number of the nozzles is not limited, and a mounting position of each nozzle on the unmanned aerial vehicle 21 is not limited either. In some exemplary embodiments, the unmanned aerial vehicle 21 may be an agricultural unmanned aerial vehicle. Four groups of nozzles may be disposed on the unmanned aerial vehicle 21, and each group of nozzles includes two nozzles. The nozzles on the unmanned aerial vehicle 21 may be configured to perform a spraying task on crops in a target area 23. In these exemplary embodiments, types of crops are not limited. For example, the crops may be fruit trees or vegetation. As shown in FIG. 1, the method in these exemplary embodiments may include the following steps.

Step S101: obtaining location information and attitude information of the unmanned aerial vehicle.

In these exemplary embodiments, a positioning system and an attitude sensor (for example, an inertial measurement unit (IMU)) may be disposed on the unmanned aerial vehicle 21, where the positioning system may be configured to determine the location information of the unmanned aerial vehicle 21, and the IMU may be configured to detect the attitude information of the unmanned aerial vehicle 21. A control device for the unmanned aerial vehicle 21 may obtain the location information of the unmanned aerial vehicle 21 by using the positioning system, and obtain the attitude information of the unmanned aerial vehicle 21 by using the IMU. The positioning system may include a satellite positioning receiver, for example, a GPS receiver, an RTK positioning receiver, or a BeiDou receiver. In these exemplary embodiments, the control device for the unmanned aerial vehicle 21 may be a control device disposed on the unmanned aerial vehicle 21. For example, the control device may be a flight controller of the unmanned aerial vehicle 21, or may be another general-purpose or dedicated controller or processor on the unmanned aerial vehicle 21. In other exemplary embodiments, the control device for the unmanned aerial vehicle 21 may be a ground control terminal corresponding to the unmanned aerial vehicle 21, for example, a remote control, a smartphone, a tablet computer, a notebook computer, or a head-mounted device.

Step S102: determining a spraying area corresponding to each nozzle in the target area based on the location information of the unmanned aerial vehicle and the attitude information of the unmanned aerial vehicle.

After obtaining the location information and attitude information of the unmanned aerial vehicle 21, the control device for the unmanned aerial vehicle 21 may determine a spraying area of each nozzle in the target area 23 based on the location information and the attitude information of the unmanned aerial vehicle 21.

In some exemplary embodiments, the determining of the spraying area of each nozzle in the target area based on the location information of the unmanned aerial vehicle and the attitude information of the unmanned aerial vehicle may include: determining location information of each nozzle based on the location information of the unmanned aerial vehicle and the attitude information of the unmanned aerial vehicle; and determining the spraying area of each nozzle in the target area based on the location information of each nozzle and a spraying width of each nozzle.

For example, the location information of the unmanned aerial vehicle 21 may be a coordinate position of the unmanned aerial vehicle 21 in a three-dimensional space, and the control device for the unmanned aerial vehicle 21 may determine location information of each nozzle based on the coordinate position of the unmanned aerial vehicle 21 in the three-dimensional space, the attitude information of the unmanned aerial vehicle 21, and the mounting position of each nozzle on the unmanned aerial vehicle 21, where the location information of each nozzle may be a coordinate position of each nozzle in the three-dimensional space. Further, the control device may determine a spraying area of each nozzle in the target area 23 based on the coordinate position of each nozzle in the three-dimensional space and the spraying width of each nozzle. The spraying width of each nozzle may be fixed. For example, the spraying width of each nozzle may be fixed in the control device for the unmanned aerial vehicle 21. In some exemplary embodiments, the spraying width of each nozzle may be adjustable. For example, the spraying width of each nozzle may be adjusted based on a control instruction of a user. For example, the user may set the spraying width of each nozzle by using the ground control terminal. The ground control terminal may generate a control instruction based on the settings of the user, and send the control instruction to the unmanned aerial vehicle, and the unmanned aerial vehicle may adjust the spraying width of each nozzle based on the control instruction. In some exemplary embodiments, the spraying width of each nozzle may be adjusted based on a flight height of the unmanned aerial vehicle. For example, when the flight height of the unmanned aerial vehicle is lower than a preset height, the spraying width of each nozzle may be reduced; or when the flight height of the unmanned aerial vehicle is higher than a preset height, the spraying width of each nozzle may be increased. When determining the spraying area of each nozzle in the target area, the control device for the unmanned aerial vehicle 21 may determine a projected point of each nozzle in the target area based on the location information of each nozzle, and determine the spraying area of each nozzle in the target area by using the projected point of each nozzle in the target area as an origin and using the spraying width of each nozzle as a spraying diameter. Herein, the spraying area may be circular. The circular spraying area may be merely used as an example of the spraying area in these exemplary embodiments, and does not constitute a limitation on this embodiment. Other existing spraying areas or spraying areas that may appear in the future may all be applicable to this embodiment.

As shown in FIG. 2, A may indicate a projected point of a nozzle 22 in the target area 23, and 24 may indicate a spraying area of the nozzle 22 in the target area 23. Methods for determining spraying areas of other nozzles may be similar to this, and may be not described one by one herein.

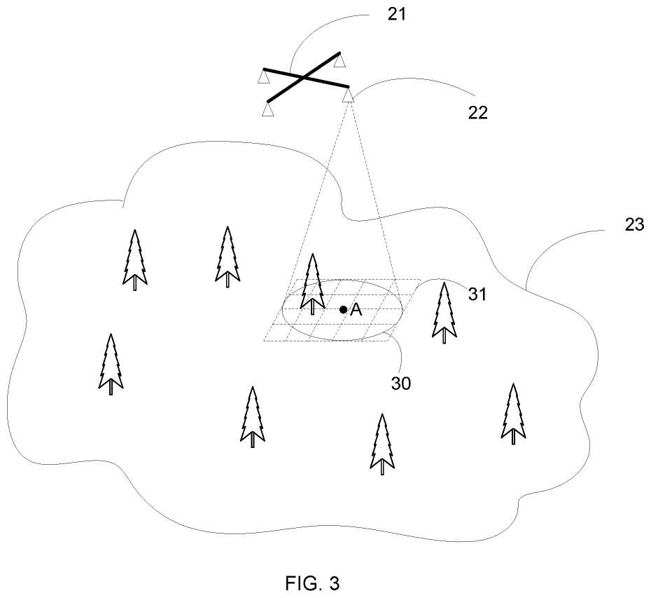

In other exemplary embodiments, the spraying area of each nozzle in the target area 23 may also be a gridded area. As shown in FIG. 3, 30 may indicate a circle taking a projected point A of a nozzle 22 in the target area 23 as a center and taking a spraying width of the nozzle 22 as a diameter. An outer-tangent rectangular area 31 and a plurality of grid areas in the outer-tangent rectangular area 31 may be obtained by performing gridding processing on the circle 30, that is, the outer-tangent rectangular area 31 may be a gridded area. Herein, the outer-tangent rectangular area 31 may be used as a spraying area of the nozzle 22 in the target area 23. Methods for determining spraying areas of other nozzles may be similar to this and may be not described one by one herein.

In another feasible implementation, the determining of the spraying area of each nozzle in the target area based on the location information of the unmanned aerial vehicle and the attitude information of the unmanned aerial vehicle may include: determining a spraying range of the unmanned aerial vehicle in the target area based on the location information of the unmanned aerial vehicle and a spraying width of the unmanned aerial vehicle; and determining, from the spraying range of the unmanned aerial vehicle in the target area, the spraying area of each nozzle in the target area based on the attitude information of the unmanned aerial vehicle.

For example, the location information of the unmanned aerial vehicle 21 may be the coordinate position of the unmanned aerial vehicle 21 in the three-dimensional space, and a spraying range of the unmanned aerial vehicle 21 in the target area 23 may be determined based on the coordinate position of the unmanned aerial vehicle 21 in the three-dimensional space and the spraying width of the unmanned aerial vehicle 21.

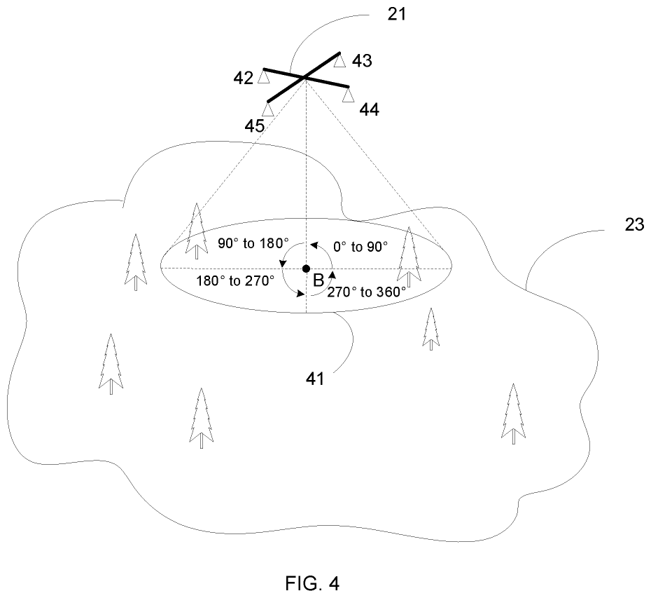

As shown in FIG. 4, the coordinate position of the unmanned aerial vehicle 21 in the three-dimensional space may be a coordinate position of a central point of the unmanned aerial vehicle 21 in the three-dimensional space. The control device for the unmanned aerial vehicle 21 may determine a projected point of the central point of the unmanned aerial vehicle 21 in the target area 23 based on the coordinate position of the central point of the unmanned aerial vehicle 21 in the three-dimensional space. For example, the projected point may be a point B. A circular area 41 taking the point B as a center and taking the spraying width of the unmanned aerial vehicle 21 as a diameter may be a spraying range of the unmanned aerial vehicle 21 in the target area 23. Likewise, the spraying width of the unmanned aerial vehicle 21 may be fixed or adjustable. For example, this may be the same as the spraying width of the nozzle and is not described again herein. In addition, a shape of the spraying range of the unmanned aerial vehicle 21 in the target area 23 is not limited in these exemplary embodiments. FIG. 4 is merely an example for description. In other exemplary embodiments, the shape of the spraying range of the unmanned aerial vehicle 21 in the target area 23 may also be a shape different from a circle. Further, the control device may determine, from the spraying range, the spraying area corresponding to each nozzle based on the spraying range of the unmanned aerial vehicle 21 in the target area 23 and the attitude information of the unmanned aerial vehicle 21.

As shown in FIG. 4, four nozzles, i.e., a nozzle 42, a nozzle 43, a nozzle 44, and a nozzle 45, may be disposed on the unmanned aerial vehicle 21. The control device may determine, in a spraying range 41, a spraying area corresponding to each nozzle based on the attitude information of the unmanned aerial vehicle 21 and the mounting position of each nozzle on the unmanned aerial vehicle 21. For example, a spraying area corresponding to the nozzle 43 in the spraying range 41 may be a sectoral area in a range from 0° to 90° in the spraying range 41, a spraying area corresponding to the nozzle 42 in the spraying range 41 may be a sectoral area in a range from 90° to 180° in the spraying range 41, a spraying area corresponding to the nozzle 45 in the spraying range 41 may be a sectoral area in a range from 180° to 270° in the spraying range 41, and a spraying area corresponding to the nozzle 44 in the spraying range 41 may be a sectoral area in a range from 270° to 360° in the spraying range 41.

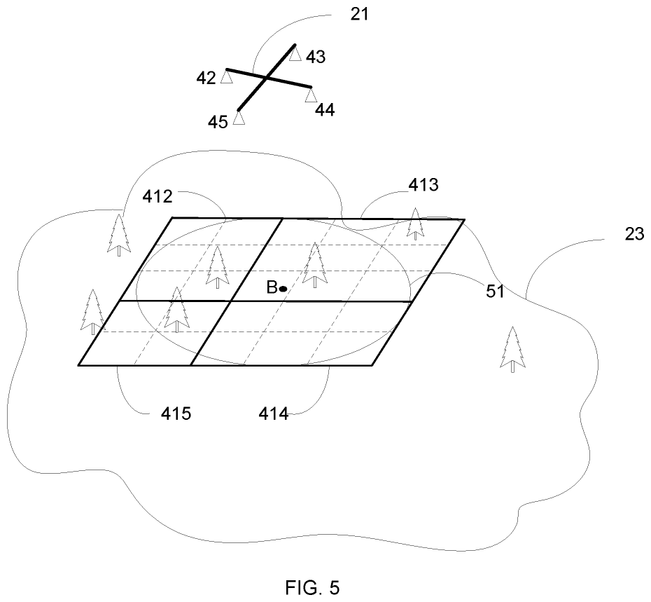

In other exemplary embodiments, the spraying area of each nozzle in the target area 23 may also be a gridded area. As shown in FIG. 5, 51 may indicate a circle taking a projected point B of the unmanned aerial vehicle 21 in the target area 23 as a center and taking the spraying width of the unmanned aerial vehicle 21 as a diameter. An outer-tangent rectangular area and a plurality of grid areas in the outer-tangent rectangular area may be obtained by performing gridding processing on the circle 51. Herein, the outer-tangent rectangular area may be used as a spraying range of the unmanned aerial vehicle 21 in the target area 23. Further, a spraying area corresponding to each nozzle in the spraying range may be determined based on the attitude information of the unmanned aerial vehicle 21 and the mounting position of each nozzle on the unmanned aerial vehicle 21. For example, a spraying area corresponding to the nozzle 43 in the spraying range may be a gridded area 413, a spraying area corresponding to the nozzle 42 in the spraying range may be a gridded area 412, a spraying area corresponding to the nozzle 45 in the spraying range may be a gridded area 415, and a spraying area corresponding to the nozzle 44 in the spraying range may be a gridded area 414. As shown in FIG. 5, each of the gridded areas 412 to 415 may include a plurality of grid areas, where the grid areas may be grids indicated by dashed lines shown in FIG. 5. Each of the gridded areas 412 to 415 may be an area indicated by solid lines and including a plurality of grid areas.

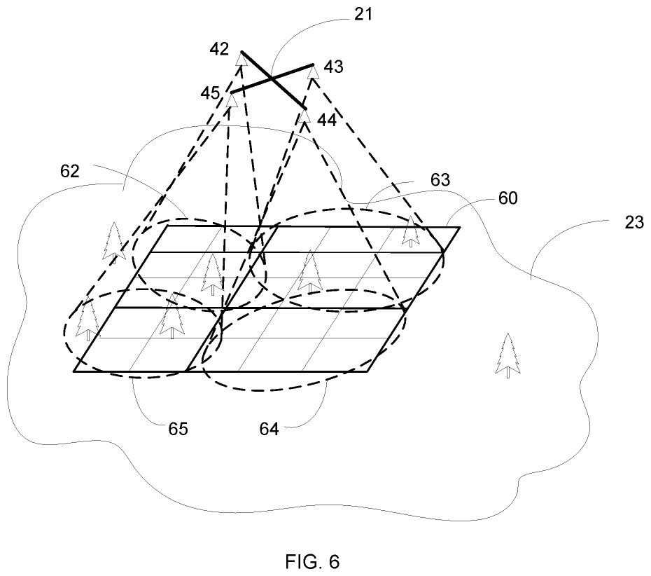

In other exemplary embodiments, the spraying area of each nozzle in the target area 23 may also be a circular area, and the spraying area may include a plurality of grid areas. As shown in FIG. 6, 60 indicates an outer-tangent rectangular area of a circle taking the projected point of the unmanned aerial vehicle 21 in the target area 23 as a center and taking the spraying width of the unmanned aerial vehicle 21 as a diameter. A plurality of grid areas corresponding to the outer-tangent rectangular area 60 may be obtained by performing gridding processing on the outer-tangent rectangular area 60. Herein, the outer-tangent rectangular area 60 may be used as a spraying range of the unmanned aerial vehicle 21 in the target area 23. Further, a spraying area corresponding to each nozzle in the spraying range may be determined based on the attitude information of the unmanned aerial vehicle 21 and the mounting position of each nozzle on the unmanned aerial vehicle 21. For example, a spraying area corresponding to the nozzle 43 in the spraying range may be a circular area 63, a spraying area corresponding to the nozzle 42 in the spraying range may be a circular area 62, a spraying area corresponding to the nozzle 45 in the spraying range may be a circular area 65, and a spraying area corresponding to the nozzle 44 in the spraying range may be a circular area 64. In addition, each of the circular area 63, the circular area 62, the circular area 65, and the circular area 64 may include a plurality of grid areas.

It may be understood that FIG. 2 to FIG. 6 show several examples of determining the spraying area of each nozzle in the target area, and the present application is not specifically limited in these exemplary embodiments. Other existing methods for determining a spraying area of each nozzle in the target area or methods that may occur in the future may all be applied to this embodiment.

Step S103: determining whether there are one or more target objects in the spraying area corresponding to each nozzle.

After determining the spraying area corresponding to each nozzle of the unmanned aerial vehicle 21 based on the foregoing several feasible methods, the control device for the unmanned aerial vehicle 21 may need to further determine whether there are crops in the spraying area corresponding to each nozzle. Taking FIG. 5 as an example, the control device needs to determine whether there are crops in the spraying area 412, the spraying area 413, the spraying area 414, and the spraying area 415.

Step S104: controlling the nozzle to be ON upon determining that there are at least one target objects in the spraying area of the nozzle, otherwise controlling the nozzle to be OFF.

For example, when the control device for the unmanned aerial vehicle 21 determines that there are crops in the spraying area 412, the spraying area 413, and the spraying area 415 but there are no crops in the spraying area 414, the control device may control the nozzle 42, the nozzle 43, and the nozzle 45 to be ON, and control the nozzle 44 to be OFF.

In some exemplary embodiments, controlling the nozzle to be ON when it is determined that there are crops in the spraying area of the nozzle, otherwise controlling the nozzle to be OFF may include: when it is determined that there are crops in the spraying area of the nozzle, sending a control instruction to a nozzle control system of the unmanned aerial vehicle, where the control instruction is used to control the nozzle to be ON; or when it is determined that there are no crops in the spraying area of the nozzle, sending a control instruction to a nozzle control system of the unmanned aerial vehicle, where the control instruction may be used to control the nozzle to be OFF.

For example, ON or OFF of the nozzle on the unmanned aerial vehicle 21 may be controlled by the nozzle control system of the unmanned aerial vehicle 21. When it is determined that there are crops in the spraying area 412, the spraying area 413, and the spraying area 415, the control device for the unmanned aerial vehicle 21 sends a control instruction to the nozzle control system of the unmanned aerial vehicle 21, where the control instruction may be used to control the nozzle 42, the nozzle 43, and the nozzle 45 to be ON; and after receiving the control instruction, the nozzle control system turns on the nozzle 42, the nozzle 43, and the nozzle 45. When it is determined that there are no crops in the spraying area 414, the control device for the unmanned aerial vehicle 21 sends a control instruction to the nozzle control system of the unmanned aerial vehicle 21, where the control instruction may be used to control the nozzle 44 to be OFF; and after receiving the control instruction, the nozzle control system turns off the nozzle 44.

In the present embodiment, by determining the spraying area of each nozzle in the target area based on the location information of the unmanned aerial vehicle and the attitude information of the unmanned aerial vehicle and further determining whether there are crops in the spraying area corresponding to each nozzle, which nozzle corresponds to a spraying area with crops and which nozzle corresponds to a spraying area without crops can be determined; and if there are crops in the spraying area of a nozzle, the nozzle may be controlled to be ON, otherwise, the nozzle may be controlled to be OFF. Therefore, waste of pesticide can be effectively avoided in comparison with an operation mode of turning on all nozzles of an unmanned aerial vehicle to spray simultaneously.

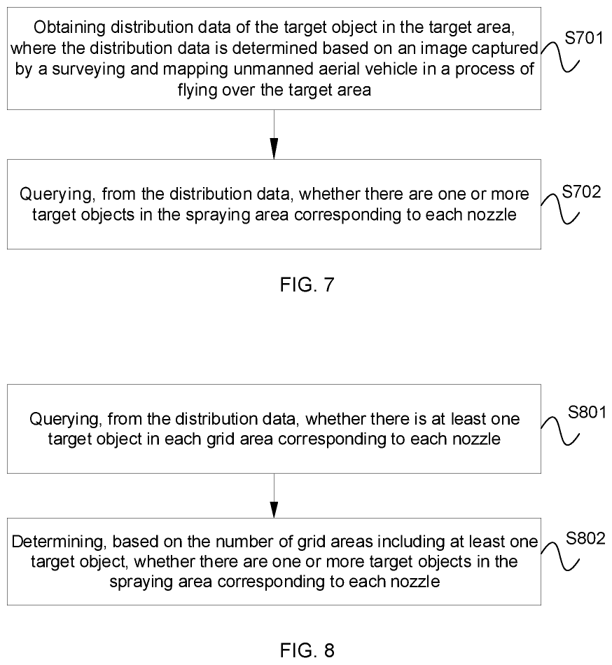

An embodiment of the present disclosure provides a method for controlling an unmanned aerial vehicle. FIG. 7 is a flowchart of a method for controlling an unmanned aerial vehicle according to another embodiment of the present disclosure. As shown in FIG. 7, on a basis of the embodiment shown in FIG. 1, the determining whether there are crops in the spraying area corresponding to each nozzle may include the following step(s).

Step S701: obtaining distribution data of the target object in the target area, where the distribution data is determined based on an image captured by a surveying and mapping unmanned aerial vehicle in a process of flying over the target area. For example, the distribution data may be a distribution status diagram of the crops. Accordingly, this step may become obtaining a distribution status diagram of crops in the target area, where the distribution status diagram of crops in the target area is determined based on an image captured by a surveying and mapping unmanned aerial vehicle in a process of flying over the target area. Merely for illustration purposes, in the following description, distribution status diagram will be used as an example of the distribution data. However, one of ordinary skill in the art may understand that any data that reflect the distribution of the crops may be implemented in the methods of the present disclosure. For example, a crop distribution map may also be used in the methods.

In some exemplary embodiments, the distribution status diagram of crops in the target area may be determined based on three-dimensional point cloud information of the target area, and the three-dimensional point cloud information of the target area may be generated based on the image captured by the surveying and mapping unmanned aerial vehicle in the process of flying in the target area.

In these exemplary embodiments, before the unmanned aerial vehicle 21 such as the agricultural unmanned aerial vehicle performs the spraying task in the target area 23, the surveying and mapping unmanned aerial vehicle may fly in the target area 23. In the process of flying, the surveying and mapping unmanned aerial vehicle may shoot images in real-time, where each image may be an image of a part of the target area 23. The surveying and mapping unmanned aerial vehicle may record location information of the surveying and mapping unmanned aerial vehicle and attitude information of a gimbal of the surveying and mapping unmanned aerial vehicle when shooting each image. For example, for each image, there may be corresponding location information of the surveying and mapping unmanned aerial vehicle and attitude information of the gimbal. Each image shot by the surveying and mapping unmanned aerial vehicle and the location information of the surveying and mapping unmanned aerial vehicle and the attitude information of the gimbal that correspond to each image may be stored in a built-in memory or an external memory of the surveying and mapping unmanned aerial vehicle. Taking a secure digital memory card (SD card) as an example of the external memory, after the surveying and mapping unmanned aerial vehicle completes a flight task, the user may remove the SD card from the surveying and mapping unmanned aerial vehicle, and insert the SD card into a computer, for example, a personal computer (PC). The computer may read each image, and the location information of the surveying and mapping unmanned aerial vehicle and the attitude information of the gimbal that correspond to each image that are stored in the SD card, and further generate, based on each image, and the location information of the surveying and mapping unmanned aerial vehicle and the attitude information of the gimbal that correspond to each image, a three-dimensional point cloud corresponding to the target area 23, where each three-dimensional point in the three-dimensional point cloud may correspond to three-dimensional coordinates and color information. Further, the computer may generate the distribution status diagram of crops in the target area 23 based on the three-dimensional point cloud corresponding to the target area 23. In some exemplary embodiments, the personal computer may input the three-dimensional point cloud information to a neural network model that is well trained beforehand, where the neural network model that is well trained beforehand may perform recognition on the three-dimensional point cloud information to output the distribution status diagram of crops in the target area 23. The distribution status diagram of crops in the target area 23 may be a semantic map of the target area.

Step S702: querying, from the distribution data, whether there are one or more target objects in the spraying area corresponding to each nozzle.

In these exemplary embodiments, when the unmanned aerial vehicle 21 such as the agricultural unmanned aerial vehicle performs the spraying task in the target area 23, the unmanned aerial vehicle 21 may pre-store the distribution status diagram. When the control device determines the spraying area of each nozzle of the unmanned aerial vehicle 21 in the target area 23, the control device may query, from the distribution status diagram, whether there are crops in the spraying area of each nozzle in the target area 23.

In some exemplary embodiments, the spraying area may include a plurality of grid areas, and the querying, from the distribution status diagram, whether there are crops in the spraying area corresponding to each nozzle may include the following steps, as shown in FIG. 8.

Step S801: querying, from the distribution data, whether there is at least one target object in each grid area corresponding to each nozzle.

As shown in FIG. 3, FIG. 5, and FIG. 6, the spraying area of each nozzle in the target area 23 may include a plurality of grid areas. To determine whether there are crops in the spraying area of each nozzle in the target area 23, the control device may first query, from the distribution status diagram, whether there are crops in each of the plurality of grid areas corresponding to the spraying area of each nozzle in the target area 23. Taking FIG. 5 as an example, when determining whether there are crops in the spraying area 413 corresponding to the nozzle 43, the control device may query, from the distribution status diagram, whether there are crops in each of nine grid areas corresponding to the spraying area 413.

In some exemplary embodiments, the distribution status diagram of crops in the target area may include location information of each unit area in the target area and identification information corresponding to each unit area, where the identification information may be used to indicate whether there are crops in the unit area, and the grid area may be larger than or equal to the unit area.

As described above, the computer may generate the distribution status diagram of crops in the target area 23 based on the three-dimensional point cloud corresponding to the target area 23. For example, the computer may input the three-dimensional point cloud to the neural network model that is well trained beforehand, and the neural network model may recognize whether there are crops in each unit area in the target area 23. In some exemplary embodiments, the target area 23 may be an area in the three-dimensional space, and each unit area in the target area 23 may also be an area in the three-dimensional space. For example, the target area 23 may be formed by unit areas, where the unit area may be, for example, an area of 1 cubic centimeter. For example, the neural network model may output three-dimensional coordinates of a geometric center of each unit area and the identification information corresponding to each unit area, where the identification information may be used to indicate whether there are crops in the unit area. For example, the identification information may indicate that there are objects such as fruit trees, a utility pole, a pool, or weeds in the unit area. The fruit trees may be crops to be sprayed, but the utility pole, the pool, or weeds may be not crops to be sprayed. Correspondingly, the distribution status diagram of the target area 23 may include the three-dimensional coordinates of the geometric center of each unit area in the target area 23 and the identification information corresponding to each unit area.

The plurality of grid areas corresponding to each nozzle as shown in FIG. 5 may also be areas in the three-dimensional space. In some exemplary embodiments, each grid area may be larger than or equal to the unit area. For example, each grid area may be an area of 1 cubic meter. Therefore, each grid area may include a plurality of unit areas.

The querying of whether there are crops in each of the plurality of grid areas corresponding to each nozzle from the distribution status diagram may include: determining, based on the location information of each unit area included in the distribution status diagram and location information of each of the plurality of grid areas corresponding to each nozzle, unit areas covered by each of the plurality of grid areas corresponding to each nozzle; determining the number of unit areas whose identification information is target identification information, in the unit areas covered by each of the plurality of grid areas corresponding to each nozzle; and determining, based on the number, whether there are crops in each of the plurality of grid areas corresponding to each nozzle.

In these exemplary embodiments, the target area, the unit area, and the grid area may also be areas in a plane. For example, each grid area may be an area of 1 square meter, each unit area may be an area of 1 square centimeter, and each grid area may include a plurality of unit areas.

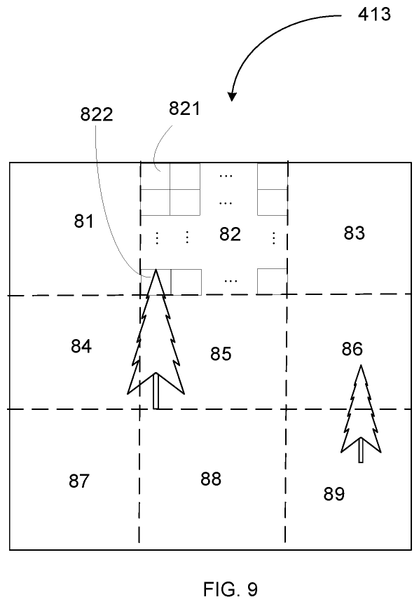

Taking the spraying area 413 corresponding to the nozzle 43 as an example, the spraying area 413 may include nine grid areas, which are grid areas 81 to 89 in sequence, as shown in FIG. 9. When the control device for the unmanned aerial vehicle 21 queries, from the distribution status diagram, whether there are crops in each of the nine grid areas corresponding to the nozzle 43, the control device may determine, based on the location information of each unit area included in the distribution status diagram and location information of each of the nine grid areas, unit areas covered by each of the nine grid areas. As shown in FIG. 9, the grid area 82 covers a plurality of unit areas, where 821 may indicate any one of the plurality of unit areas. Each of the plurality of unit areas covered by the grid area 82 may correspond to one piece of identification information, where the identification information may be used to indicate whether there are crops in the unit area. Herein, identification information used to indicate that there are crops in a unit area may be marked as target identification information. Therefore, the number of unit areas whose identification information is target identification information, in the plurality of unit areas covered by the grid area 82 may be counted, that is, the number of unit areas in which there are crops in the plurality of unit areas covered by the grid area 82 may be counted. As shown in FIG. 9, it is assumed that only identification information corresponding to a unit area 822 in the plurality of unit areas covered by the grid area 82 is the target identification information, that is, in the plurality of unit areas covered by the grid area 82, the number of unit areas whose corresponding identification information is the target identification information is 1. That is, in the plurality of unit areas covered by the grid area 82, the number of unit areas in which there are crops is 1. Likewise, in a plurality of unit areas covered by each of the grid area 81 and the grid areas 83 to 89, the number of unit areas in which there are crops may be counted. Further, based on the number of unit areas in which there are crops in the plurality of unit areas covered by each of the grid areas 81 to 89, whether there are crops in each of the nine grid areas may be determined.

In some exemplary embodiments, the determining of whether there are crops in each of the plurality of grid areas corresponding to each nozzle based on the number may include: in the unit areas covered by the grid area, if the number of unit areas whose identification information is target identification information is greater than or equal to 1, determining that there are crops in the grid area, otherwise, determining that there are no crops in the grid area.

As shown in FIG. 9, in the plurality of unit areas covered by the grid area 82, the number of unit areas whose corresponding identification information is the target identification information is 1, and it may be determined that there are crops in the grid area 82. For another example, in a plurality of unit areas covered by the grid area 83, if the number of unit areas whose corresponding identification information is the target identification information is 0, it may be determined that there are no crops in the grid area 83.

In other exemplary embodiments, in the plurality of unit areas covered by each grid area, only when the number of unit areas whose corresponding identification information is the target identification information is greater than or equal to a preset value, it can be considered that there are crops in the grid area. The preset value may be a positive integer greater than 1, or may be a percentage. For example, assuming that the grid area 82 covers 100 unit areas, it may be considered that there are crops in the grid area 82 only when identification information of 10% or more of the 100 unit areas is the target identification information. Herein, 10% is only an example, and other values may also be used.

Step S802: determining, based on the number of grid areas including at least one target object, whether there are one or more target objects in the spraying area corresponding to each nozzle.

By using the foregoing method, in the nine grid areas in the spraying area 413 corresponding to the nozzle 43, which grid area has crops and which grid area has no crops can be determined, and therefore the number of grid areas in which there are crops, in the nine grid areas, can be determined. As shown in FIG. 9, it is assumed that there are crops in the grid area 82, the grid area 84, the grid area 85, the grid area 86, and the grid area 89, that is, in the nine grid areas, the number of grid areas in which there are crops is 5.

Likewise, in a plurality of grid areas in a spraying area corresponding to each of the other nozzles of the unmanned aerial vehicle, such as the nozzle 42, the nozzle 44, and the nozzle 45 shown in FIG. 5, the number of grid areas in which there are crops may be determined.

In some exemplary embodiments, the determining of whether there are crops in the spraying area corresponding to each nozzle in the plurality of grid areas corresponding to each nozzle based on the number of grid areas in which there are crops may include: if the number of grid areas in which there are crops, in the plurality of grid areas corresponding to the nozzle, is greater than or equal to 1, determining that there are crops in the spraying area corresponding to the nozzle, otherwise, determining that there are no crops in the spraying area corresponding to the nozzle.

For example, after determining the number of grid areas in which there are crops, in the plurality of grid areas in the spraying area corresponding to each nozzle of the unmanned aerial vehicle, the control device for the unmanned aerial vehicle may determine, based on the number of grid areas in which there are crops, in the plurality of grid areas in the spraying area corresponding to each nozzle, whether there are crops in the spraying area corresponding to each nozzle. In some exemplary embodiments, when the number of grid areas in which there are crops, in the plurality of grid areas in the spraying area corresponding to the nozzle is greater than or equal to 1, it may be determined that there are crops in the spraying area corresponding to the nozzle, otherwise, it may be determined that there are no crops in the spraying area corresponding to the nozzle. As shown in FIG. 9, if the number of grid areas in which there are crops in the nine grid areas in the spraying area 413 corresponding to the nozzle 43 is 5, where 5 is greater than or equal to 1, it may be determined that there are crops in the spraying area 413 corresponding to the nozzle 43. Likewise, it may be determined that there are crops in the spraying area 412 corresponding to the nozzle 42, and that there are crops in the spraying area 415 corresponding to the nozzle 45, and that there are no crops in the spraying area 414 corresponding to the nozzle 44. Therefore, the unmanned aerial vehicle can control the nozzle 43, the nozzle 42, and the nozzle 45 to be ON, and control the nozzle 44 to be OFF.

In these exemplary embodiments, before the agricultural unmanned aerial vehicle performs the spraying task in the target area, the surveying and mapping unmanned aerial vehicle performs photographing on the target area, to obtain a plurality of images corresponding to the target area, location information of the surveying and mapping unmanned aerial vehicle and attitude information of the gimbal corresponding to each image, and may determine the distribution status diagram of crops in the target area based on each image, and the location information of the surveying and mapping unmanned aerial vehicle and the attitude information of the gimbal corresponding to each image. When the agricultural unmanned aerial vehicle performs the spraying task in the target area, the agricultural unmanned aerial vehicle may query, from the distribution status diagram, whether there are crops in the spraying area corresponding to each nozzle. This may improve the accuracy of determining whether there are crops in the spraying area corresponding to each nozzle, and further improve the accuracy of controlling the nozzle, thereby avoiding waste of pesticide more effectively.

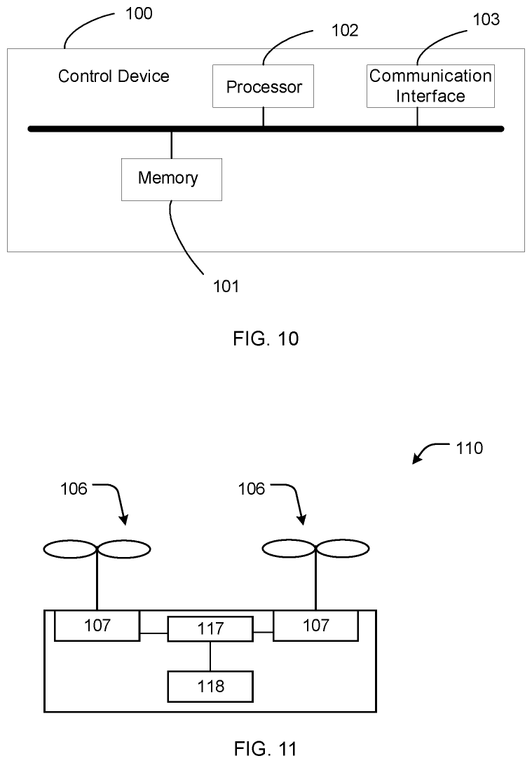

An embodiment of the present disclosure provides a control device for an unmanned aerial vehicle. FIG. 10 is a structural diagram of a control device for an unmanned aerial vehicle according to some exemplary embodiments of the present disclosure. In these exemplary embodiments, a plurality of nozzles may be disposed on the unmanned aerial vehicle, and the nozzles may be configured to perform a spraying task on crops in a target area. As shown in FIG. 10, the control device 100 may include a memory 101 and a processor 102. The memory 101 may be configured to store program code. The processor 102 may be configured to invoke the program code, and configured to perform the following operations when the program code is executed: obtaining location information and attitude information of the unmanned aerial vehicle; determining a spraying area of each nozzle in the target area based on the location information of the unmanned aerial vehicle and the attitude information of the unmanned aerial vehicle; determining whether there are crops in the spraying area corresponding to each nozzle; and when it is determined that there are crops in the spraying area of the nozzle, controlling the nozzle to be ON, otherwise controlling the nozzle to be OFF.

In some exemplary embodiments, when determining the spraying area of each nozzle in the target area based on the location information of the unmanned aerial vehicle and the attitude information of the unmanned aerial vehicle, the processor 102 may be configured to: determine location information of each nozzle based on the location information of the unmanned aerial vehicle and the attitude information of the unmanned aerial vehicle; and determine the spraying area of each nozzle in the target area based on the location information of each nozzle and a spraying width of each nozzle.

In some exemplary embodiments, when determining the spraying area of each nozzle in the target area based on the location information of the unmanned aerial vehicle and the attitude information of the unmanned aerial vehicle, the processor 102 may be configured to: determine a spraying range of the unmanned aerial vehicle in the target area based on the location information of the unmanned aerial vehicle and a spraying width of the unmanned aerial vehicle; and determine, from the spraying range of the unmanned aerial vehicle in the target area, the spraying area of each nozzle in the target area based on the attitude information of the unmanned aerial vehicle.

In some exemplary embodiments, when determining whether there are crops in the spraying area corresponding to each nozzle, the processor 102 may be configured to: obtain a distribution status diagram of crops in the target area, where the distribution status diagram of crops in the target area is determined based on an image captured by a surveying and mapping unmanned aerial vehicle in a process of flying in the target area; and query, from the distribution status diagram, whether there are crops in the spraying area corresponding to each nozzle.

In some exemplary embodiments, the distribution status diagram of crops in the target area may be determined based on three-dimensional point cloud information of the target area, and the three-dimensional point cloud information of the target area may be generated based on the image captured by the surveying and mapping unmanned aerial vehicle in the process of flying in the target area.

In some exemplary embodiments, the spraying area may include a plurality of grid areas, and when querying, from the distribution status diagram, whether there are crops in the spraying area corresponding to each nozzle, the processor 102 may be configured to: query, from the distribution status diagram, whether there are crops in each of the plurality of grid areas corresponding to each nozzle; and determine, based on the number of grid areas in which there are crops, in the plurality of grid areas corresponding to each nozzle, whether there are crops in the spraying area corresponding to each nozzle.

In some exemplary embodiments, when determining, based on the number of grid areas in which there are crops, in the plurality of grid areas corresponding to each nozzle, whether there are crops in the spraying area corresponding to each nozzle, the processor 102 may be configured to: if the number of grid areas in which there are crops, in the plurality of grid areas corresponding to the nozzle is greater than or equal to 1, determine that there are crops in the spraying area corresponding to the nozzle, otherwise determine that there are no crops in the spraying area corresponding to the nozzle.

In some exemplary embodiments, the distribution status diagram of crops in the target area may include location information of each unit area in the target area and identification information corresponding to each unit area, where the identification information may be used to indicate whether there are crops in the unit area, and the grid area may be larger than or equal to the unit area; and when querying, from the distribution status diagram, whether there are crops in each of the plurality of grid areas corresponding to each nozzle, the processor 102 may be configured to: determine, based on the location information of each unit area included in the distribution status diagram and location information of each of the plurality of grid areas corresponding to each nozzle, unit areas covered by each of the plurality of grid areas corresponding to each nozzle; determine the number of unit areas whose identification information is target identification information, in the unit areas covered by each of the plurality of grid areas corresponding to each nozzle; and determine, based on the number, whether there are crops in each of the plurality of grid areas corresponding to each nozzle.

In some exemplary embodiments, when determining, based on the number, whether there are crops in each of the plurality of grid areas corresponding to each nozzle, the processor 102 may be configured to: if the number of unit areas whose identification information is target identification information in the unit areas covered by the grid area is greater than or equal to 1, determine that there are crops in the grid area, otherwise determine that there are no crops in the grid area.

In some exemplary embodiments, the control device may further include a communication interface 103. When the nozzle is controlled to be ON upon determining that there are crops in the spraying area of the nozzle, otherwise the nozzle is controlled to be OFF, the processor 102 may be configured to: when the processor 102 determines that there are crops in the spraying area of the nozzle, send a control instruction to a nozzle control system of the unmanned aerial vehicle by using the communication interface 103, where the control instruction may be used to control the nozzle to be ON; or when the processor 102 determines that there are no crops in the spraying area of the nozzle, send a control instruction to a nozzle control system of the unmanned aerial vehicle by using the communication interface, where the control instruction may be used to control the nozzle to be OFF.

In some exemplary embodiments, the control device may be a general-purpose computer or a special purpose computer, both may be used to implement an on-demand system for the present disclosure. The control device may be used to implement any component of the on-demand service as described herein. Although only one such computer is shown, for convenience, the computer functions relating to the on-demand service as described herein may be implemented in a distributed fashion on a number of similar platforms, to distribute the processing load.

The control device, for example, may include COM ports connected to and from a network connected thereto to facilitate data communications. The control device may also include a central processing unit (CPU), in the form of one or more processors, for executing program instructions. The exemplary computer platform may include an internal communication bus, program storage and data storage of different forms, for example, a disk, and a read-only memory (ROM), or random-access memory (RAM), for various data files to be processed and/or transmitted by the computer. The exemplary computer platform may also include program instructions stored in the ROM, RAM, and/or other type of non-transitory storage medium to be executed by the CPU. The methods and/or processes of the present disclosure may be implemented as the program instructions. The control device also includes an I/O component, supporting input/output between the computer and other components therein such as user interface elements. The control device may also receive programming and data via network communications.

Merely for illustration, only one CPU and/or processor is described in the control device. However, it should be note that the control device in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the control device executes both step A and step B, it should be understood that step A and step B may also be performed by two different CPUs and/or processors jointly or separately in the control device (e.g., the first processor executes step A and the second processor executes step B, or the first and second processors jointly execute steps A and B).

Specific principles and implementations of the control device provided in these exemplary embodiments of the present disclosure may be similar to those in the foregoing embodiment. Details are not described again herein.

In these exemplary embodiments, by determining the spraying area of each nozzle in the target area based on the location information of the unmanned aerial vehicle and the attitude information of the unmanned aerial vehicle and further determining whether there are crops in the spraying area corresponding to each nozzle, which nozzle corresponds to a spraying area with crops and which nozzle corresponds to a spraying area without crops can be determined; and if there are crops in the spraying area of a nozzle, the nozzle may be controlled to be ON, otherwise, the nozzle may be controlled to be OFF. Therefore, waste of pesticide can be effectively avoided in comparison with an operation mode of turning on all nozzles of an unmanned aerial vehicle to spray simultaneously.

An embodiment of the present disclosure provides a spraying system of an unmanned aerial vehicle. The unmanned aerial vehicle performs a spraying task on crops in a target area. The spraying system of the unmanned aerial vehicle may include: a plurality of nozzles, a nozzle control system, and the control device in the foregoing embodiment, where the plurality of nozzles may be mounted on a fuselage of the unmanned aerial vehicle; and the nozzle control system may be configured to control the plurality of nozzles to be ON or OFF. Specific principles and implementations of the control device may be similar to those in the foregoing embodiment. Details are not described again herein.

An embodiment of the present disclosure provides an unmanned aerial vehicle. FIG. 11 is a structural diagram of an unmanned aerial vehicle according to some exemplary embodiments of the present disclosure. As shown in FIG. 11, the unmanned aerial vehicle 110 may include a fuselage, a power system, and a flight controller 118. The power system may include at least one of the following: a motor 107, a propeller 106, and an electronic speed governor 117. The power system may be mounted in the fuselage, and configured to supply power for flying. The flight controller 118 may be communicatively connected to the power system, and may be configured to control the flight of the unmanned aerial vehicle. In addition, the unmanned aerial vehicle 110 may further include the foregoing spraying system of the unmanned aerial vehicle. Specific principles and implementations of the spraying system of the unmanned aerial vehicle may be similar to those in the foregoing embodiment. Details are not described again herein.

In some exemplary embodiments, the unmanned aerial vehicle 110 may be an agricultural unmanned aerial vehicle.

In these exemplary embodiments, by determining the spraying area of each nozzle in the target area based on the location information of the unmanned aerial vehicle and the attitude information of the unmanned aerial vehicle and further determining whether there are crops in the spraying area corresponding to each nozzle, which nozzle corresponds to a spraying area with crops and which nozzle corresponds to a spraying area without crops can be determined; and if there are crops in the spraying area of a nozzle, the nozzle may be controlled to be ON, otherwise, the nozzle may be controlled to be OFF. Therefore, waste of pesticide can be effectively avoided in comparison with an operation mode of turning on all nozzles of an unmanned aerial vehicle to spray simultaneously.

In addition, this embodiment further provides a computer-readable storage medium, where the computer-readable storage medium stores a computer program thereon, and the computer program may be executed by a processor to implement the method for controlling an unmanned aerial vehicle in the foregoing embodiment.

In the several embodiments provided in the present disclosure, it should be understood that the disclosed apparatus and method may be implemented in other manners. For example, the described apparatus embodiment is merely an example. For example, the unit division may be merely logical function division and may be other division in actual implementation. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objectives of the solutions of the embodiments.

In addition, functional units in the embodiments of the present disclosure may be integrated into one processing unit, or each of the units may exist alone physically, or two or more units may be integrated into one unit. The integrated unit may be implemented in a form of hardware or may be implemented in a form of hardware in addition to a software functional unit.

When the foregoing integrated unit is implemented in a form of a software functional unit, the integrated unit may be stored in a computer-readable storage medium. The software functional unit may be stored in a storage medium and may include several instructions for instructing a computer device (which may be a personal computer, a server, a network device, or the like) or a processor to perform a part of the steps of the methods described in the embodiments of the present disclosure. The foregoing storage medium may include: any medium that can store program code, such as a USB flash drive, a removable hard disk, a read-only memory (ROM), a random-access memory (RAM), a magnetic disk, or an optical disc.

It may be clearly understood by persons skilled in the art that, for the purpose of convenient and brief description, division of the foregoing functional modules is used as an example for illustration. In actual application, the foregoing functions can be allocated to different functional modules and implemented according to a requirement, that is, an internal structure of the apparatus is divided into different functional modules to implement all or a part of the functions described above. For a detailed working process of the foregoing apparatus, reference may be made to a corresponding process in the foregoing method embodiments, and details are not described again herein.

Finally, it should be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

1. A method for controlling an unmanned aerial vehicle, comprising:
obtaining location information of an unmanned aerial vehicle having a plurality of nozzles disposed thereon and attitude information of the unmanned aerial vehicle; and
for each nozzle:
determining a spraying area corresponding to the nozzle in a target area based on the location information and the attitude information;
determining whether there are one or more target object in the spraying area corresponding to the nozzle;
controlling the nozzle to be ON in response to determining that there are one or more target objects in the spraying area; and
controlling the nozzle to be OFF in response to determining that there is no target object in the spaying area.

2. The method according to claim 1, wherein for each nozzle, the determining of the spraying area corresponding to the nozzle in the target area includes:
determining location information of the nozzle based on the location information of the unmanned aerial vehicle and the attitude information of the unmanned aerial vehicle; and
determining the spraying area corresponding to the nozzle in the target area based on the location information of the nozzle and a spraying width of the nozzle.

3. The method according to claim 1, wherein for each nozzle, the determining of the spraying area corresponding to the nozzle in the target area includes:
determining a spraying range of the unmanned aerial vehicle in the target area based on the location information of the unmanned aerial vehicle and a spraying width of the unmanned aerial vehicle; and
determining, from the spraying range, the spraying area of the nozzle in the target area based on the attitude information of the unmanned aerial vehicle.

4. The method according to claim 1, further comprising determining whether there are one or more the target objects in the spraying area, including:
obtaining distribution data of the target object in the target area; and
querying whether there are one or more target objects in the spraying area from the distribution data.

5. The method according to claim 4, wherein the distribution data is determined based on three-dimensional point cloud information of the target area, and
the three-dimensional point cloud information is generated based on the image.

6. The method according to claim 4, wherein the spraying area includes a plurality of grid areas, and
the querying of whether there are one or more target objects in the spraying area includes:
querying, from the distribution data, whether there is at least one target object in each grid area; and
determining whether there are one or more target objects in the spraying area based on the number of grid areas including at least one target object.

7. The method according to claim 6, wherein the determining of whether there are one or more target objects in the spraying area includes:
determining that the number of grid areas including at least one target object is greater than or equal to 1, and then determining that there are one or more target objects in the spraying area, and
determining that the number of grid areas including at least one target object is less than 1, and then determining that there is no target object in the spraying area.

8. The method according to claim 6, wherein
the target area includes at least one unit area smaller than or equal to the grid area;
the distribution data includes:
location information of each unit area of the at least one unit area, and
identification information of each unit area, indicating whether there is at least one target object in the unit area, and
the querying of whether there is at least one target object in each grid area includes:
determining unit areas covered by each grid area based on the location information of each unit area and location information of each grid area;
determining, in the unit areas covered by each grid area, the number of unit areas whose identification information is target identification information; and
determining whether there is at least one target object in each grid area based on the number.

9. The method according to claim 8, wherein the determining of whether there is at least one target object in each grid area includes:
for each grid area:
determining that the number of unit areas whose identification information is the target identification information is greater than or equal to 1, and then determining that there is at least one target object in the grid area, and
determining that the number of unit areas whose identification information is the target identification information is less than 1, and then determining that there is no target object in the grid area.

10. The method according to claim 1, wherein
the controlling of the nozzle to be ON includes:
determining that there are one or more target objects in the spraying area of the nozzle, and
sending a control instruction to a nozzle control system of the unmanned aerial vehicle to control the nozzle to be ON,
the controlling of the nozzle to be OFF includes:
determining that there is no target object in the spraying area of the nozzle, and
sending a control instruction to the nozzle control system of the unmanned aerial vehicle to control the nozzle to be OFF.

11. A device for controlling an unmanned aerial vehicle, comprising:
one or more storage media storing one or more sets of instructions for controlling an unmanned aerial vehicle; and
one or more processors, during operation, to execute the one or more sets of instructions to:
obtain location information of an unmanned aerial vehicle having a plurality of nozzles disposed thereon and attitude information of the unmanned aerial vehicle, and
for each nozzle:
determine a spraying area corresponding to the nozzle in a target area based on the location information and the attitude information;
determining whether there are one or more target object in the spraying area corresponding to the nozzle;
controlling the nozzle to be ON in response to determine that there are one or more target objects in the spraying area; and
controlling the nozzle to be OFF in response to determine that there is no target object in the spaying area.

12. The device according to claim 11, wherein for each nozzle, to determine the spraying area corresponding to the nozzle in the target area, the one or more processors further execute the one or more sets of instructions to:
determine location information of the nozzle based on the location information of the unmanned aerial vehicle and the attitude information of the unmanned aerial vehicle; and
determine the spraying area corresponding to the nozzle in the target area based on the location information of the nozzle and a spraying width of the nozzle.

13. The device according to claim 11, wherein for each nozzle, to determine the spraying area corresponding to the nozzle in the target area, the one or more processors further execute the one or more sets of instructions to:
determine a spraying range of the unmanned aerial vehicle in the target area based on the location information of the unmanned aerial vehicle and a spraying width of the unmanned aerial vehicle; and
determine, from the spraying range, the spraying area of the nozzle in the target area based on the attitude information of the unmanned aerial vehicle.

14. The device according to claim 11, wherein the one or more processors further execute the one or more sets of instructions to determine whether there are one or more the target objects in the spraying area by:
obtaining a distribution data of target objects in the target area, and
querying whether there are one or more target objects in the spraying area from the distribution data.

15. The device according to claim 14, wherein the distribution data is determined based on three-dimensional point cloud information of the target area, and
the three-dimensional point cloud information is generated based on the image.

16. The device according to claim 14, wherein the spraying area includes a plurality of grid areas, and
to query whether there are one or more target objects in the spraying area, the one or more processors further execute the one or more set of instructions to:
query, from the distribution data, whether there is at least one target object in each grid area, and
determine whether there are one or more target objects in the spraying area based on the number of grid areas including at least one target object.

17. The device according to claim 16, wherein to determine whether there are one or more target objects in the spraying area, the one or more processors further execute the one or more set of instructions to:
determine that the number of grid areas including at least one target object is greater than or equal to 1, and then determining that there are one or more target objects in the spraying area, and
determine that the number of grid areas including at least one target object is less than 1, and then determining that there is no target object in the spraying area.

18. The device according to claim 16, wherein
the target area includes at least one unit area smaller than or equal to the grid area;
the distribution data includes:
location information of each unit area of the at least one unit area, and
identification information of each unit area, indicating whether there is at least one target object in the unit area, and
to query whether there is at least one target object in each grid area, the one or more processors further execute the one or more set of instructions to:
determining unit areas covered by each grid area based on the location information of each unit area and location information of each grid area;
determining, in the unit areas covered by each grid area, the number of unit areas whose identification information is target identification information; and
determining whether there is at least one target object in each grid area based on the number.

19. The device according to claim 18, wherein to determine whether there is at least one target object in each grid area, the one or more processors further execute the one or more set of instructions to:
for each grid area:
determining that the number of unit areas whose identification information is the target identification information is greater than or equal to 1, and then determining that there is at least one target object in the grid area, and
determining that the number of unit areas whose identification information is the target identification information is less than 1, and then determining that there is no target object in the grid area.

20. The device according to claim 11, further comprising a communication interface, wherein
to control the nozzle to be ON, the one or more processors further execute the one or more set of instructions to:
determine that there are one or more target objects in the spraying area of the nozzle, and
send a control instruction to a nozzle control system of the unmanned aerial vehicle to control the nozzle to be ON; and
to control the nozzle to be OFF, the one or more processors further execute the one or more set of instructions to:
determine that there is no target object in the spraying area of the nozzle, and
send a control instruction to the nozzle control system of the unmanned aerial vehicle to control the nozzle to be OFF.

21. A spraying system of an unmanned aerial vehicle, comprising:
a plurality of nozzles, mounted on a fuselage of the unmanned aerial vehicle;
a nozzle control system, configured to control the plurality of nozzles to be ON or OFF; and
a control device, including:
one or more storage media storing one or more sets of instructions for controlling an unmanned aerial vehicle; and
one or more processors, during operation, to execute the one or more sets of instructions to:
obtain location information of an unmanned aerial vehicle having a plurality of nozzles disposed thereon and attitude information of the unmanned aerial vehicle;
for each nozzle:
determine a spraying area corresponding to the nozzle in a target area based on the location information and the attitude information;
determining whether there are one or more target object in the spraying area corresponding to the nozzle;
controlling the nozzle to be ON in response to determine that there are one or more target objects in the spraying area; and
controlling the nozzle to be OFF in response to determine that there is no target object in the spaying area.
